(19) United States
(12) Patent Application Publication
(10) Pub. No.: US 2016/0191085 A1
(43) Pub. Date: Jun. 30, 2016

(54) TRANSMIT FRONT END MODULE FOR DUAL ANTENNA APPLICATIONS

(71) Applicant: SKYWORKS SOLUTIONS, INC., Woburn, MA (US)

(72) Inventors: Reza KASNAVI, Solana Beach, CA (US); Ying SHI, Saratoga, CA (US); Ethan CHANG, Aliso Viejo, CA (US)

(21) Appl. No.: 14/824,916

(22) Filed: Aug. 12, 2015

Related U.S. Application Data
(60) Provisional application No. 62/036,879, filed on Aug. 13, 2014.

(51) Int. Cl. H04B 1/04

(52) U.S. Cl. CPC H04B 1/0458; H04B 1/0475; H04B 2001/0408

(57) ABSTRACT

Circuits, devices and modules for supporting dual or multi-antenna applications, are disclosed. In some embodiments, a front-end module includes a packaging substrate configured to receive a plurality of components, a first input port and a second input port configured to receive respective radio-frequency (RF) signals for amplification, a first antenna port and a second antenna port configured to output the amplified RF signals to respective antennas, and a front-end circuit. The front-end circuit can be implemented between the input ports and the antenna ports. The front-end circuit can include a power amplifier (PA) for each of the first and second input ports, an antenna switch configured to route the amplified RF signals from the PAs to their respective antenna ports, and a coupler implemented between the antenna switch and the antenna ports, the coupler configured to detect output power of the amplified RF signals.

### CROSS-REFERENCE TO RELATED APPLICATIONS

This application claims priority to U.S. Provisional Application No. 62/036,879 filed Aug. 13, 2014, entitled TRANSMIT FRONT END MODULE FOR DUAL ANTENNA APPLICATIONS, the disclosure of which is hereby expressly incorporated by reference herein in its entirety.

### BACKGROUND

1. Field

The present disclosure relates to RF modules used in cellular wireless systems.

2. Description of the Related Art

In cellular wireless systems, two antennas can be used to transmit and receive signals over a large cellular band. An RF front-end module can be used to manage these signals.

### SUMMARY

In accordance with some implementations, the present disclosure relates to a front-end module that includes a packaging substrate configured to receive a plurality of components, a first input port and a second input port configured to receive respective radio-frequency (RF) signals for amplification, and a first antenna port and a second antenna port configured to output the amplified RF signals to respective antennas. The front-end module also includes a front-end circuit implemented between the input ports and the antenna ports, the front-end circuit including a power amplifier (PA) for each of the first and second input ports, the front-end circuit further including an antenna switch configured to route the amplified RF signals from the PAs to their respective antenna ports, the front-end circuit further including a coupler implemented between the antenna switch and the antenna ports, the coupler configured to detect output power of the amplified RF signals.

In some embodiments, the front-end circuit of the front-end module includes substantially all components needed to couple first and second frequency band outputs of a transceiver to the respective antennas for transmit operations involving the first and second frequency bands.

In some embodiments, the first frequency band of the front-end module is a high band and the second frequency band is a low band. In some implementations, the front-end circuit of the front-end module further includes an output-matching network implemented at the output of each of the first and second PA's.

In some embodiments, the front-end circuit of the front-end module further includes a harmonic filter implemented at the output of each of the first and second output matching networks.

In some embodiments, an antenna switch of the front-end circuit includes a DPNT (double-pole N-throw) configuration, where the double poles are coupled to the first and second antenna ports through the coupler. In some implementations, the N throws and the double throws of the antenna switch are divided into a high band portion having an SPXT (single-pole X-throw) configuration and a low band portion having an SPYT (single-pole Y-throw) configuration. In some embodiments, one of the X-throws of the high band portion is connected to an output of the high band PA, and one of the Y-throws of the low band portion is connected to an output of the low band PA.

In some embodiments, the coupler is implemented as an integrated passive device (IPD), and in some embodiments, the IPD includes a dedicated coupler circuit for each of the high band and the low band.

In some embodiments, the front-end circuit of the front-end module further includes an electrostatic discharge (ESD) protection circuit implemented between each dedicated coupler circuit and the corresponding antenna port. In some implementations, the front-end circuit of the front-end module further includes a filter implemented between each dedicated coupler circuit and the corresponding antenna port.

According to some implementations, the present disclosure relates to a radio-frequency (RF) device including a transceiver configured to process RF signals. The RF device further includes a front-end module in communication with the transceiver, where the front-end module includes a packaging substrate configured to receive a plurality of components, a first input port and a second input port configured to receive respective RF signals for amplification, and a first antenna port and a second antenna port configured to output the respective amplified RF signals. The front-end module of the RF device further includes a front-end circuit implemented between the input ports and the antenna ports. The front-end circuit includes a power amplifier (PA) for each of the first and second input ports, an antenna switch configured to route the amplified RF signals from the PAs to their respective antenna ports, and a coupler implemented between the antenna switch and the antenna ports, the coupler configured to detect output power of the amplified RF signals. The RF device also includes a first antenna and a second antenna connected to the first and second antenna ports of the front-end module, respectively, the first and second antennas configured to facilitate transmission of their respective amplified RF signals.

In some implementations, the RF device includes a wireless device, and in some implementations, the wireless device is a cellular phone.

In some embodiments, the transceiver of the RF device is in communication with a baseband sub-system, and the baseband sub-system is configured to provide conversion between data and/or voice signals. In some implementations, the baseband sub-system is in communication with a user interface. In some implementations, the front-end module of the RF device is in communication with one or more low-noise amplifiers (LNAs) and amplified signals from the one or more LNAs are routed to the transceiver.

In some embodiments, the coupler of the front-end module of the RF device is implemented as an integrated passive device (IPD).

A method for fabricating a front-end module (FEM) is disclosed, in accordance with some embodiments. The method includes providing a packaging substrate configured to receive a plurality of components, setting a first input port and a second input port configured to receive respective radio-frequency (RF) signals for amplification, and setting a first antenna port and a second antenna port configured to output the amplified RF signals to respective antennas. The method also includes incorporating a front-end circuit implemented between the input ports and the antenna ports, the front-end circuit including a power amplifier (PA) for each of the first and second input ports, the front-end circuit further including an antenna switch configured to route the amplified RF signals from the PAs to their respective antenna ports, the front-end circuit further including a coupler implemented between the antenna switch and the antenna ports, the coupler configured to detect output power of the amplified RF signals.

For purposes of summarizing the disclosure, certain aspects, advantages and novel features of the inventions have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

FIG. 1 shows an exemplary block diagram of a radio-frequency module to support two or more antennas, in accordance with some embodiments.

FIG. 2 shows an exemplary block diagram of a radio-frequency module to support two or more antennas, in accordance with some embodiments.

FIG. 3 shows an exemplary switching circuit topology, in accordance with some embodiments.

FIG. 4 shows an exemplary switching circuit topology, in accordance with some embodiments.

FIG. 5 shows an exemplary coupler circuit implemented as an integrated passive device, in accordance with some embodiments.

FIG. 6 shows an exemplary coupling assembly with first and second coupling circuits, in accordance with some embodiments.

FIG. 7 shows an exemplary coupling assembly including a coupling circuit implemented in a chain configuration, in accordance with some embodiments.

FIG. 8 shows an exemplary block diagram of a wireless device, in accordance with some embodiments.

### DETAILED DESCRIPTION OF SOME EMBODIMENTS

The headings provided herein, if any, are for convenience only and do not necessarily affect the scope or meaning of the claimed invention.

Cellular wireless systems are becoming more and more complicated as demands and expectations in designs become greater. As the LTE market becomes larger, cellular band is expanding, for example, from 700 MHz to 2700 MHz. Such an expansion causes complexity to wireless systems.

For example, in traditional handset design, there can be a single antenna supporting cellular transmitting and receiving systems. However, the transmitting OTA (over the air) functionality can be limited by the antenna efficiency across the band. Usually, the high frequency (e.g., 2.5 GHz-2.7 GHz) can be a problematic range. Due to broad band matching requirements on a given antenna, the matching in high band typically cannot be fully optimized, and thus the efficiency degrades.

Due to such lower efficiency, a power amplifier needs to output higher power to meet TRP (total radiated power) requirements. As a result, the system consumes more power, and linearity typically degrades.

Some wireless designs are adopting a dedicated antenna for high frequency band(s). However, if a TX FEM (transmitting front end module) only supports one antenna, additional components need to be implemented to accommodate such a dedicated antenna. For example, in order to enable a dual antenna application, wireless devices need to add an additional switch between a TX FEM and the additional dedicated antenna feed, thereby increasing the BOM (bill-of-materials) cost and design complexity.

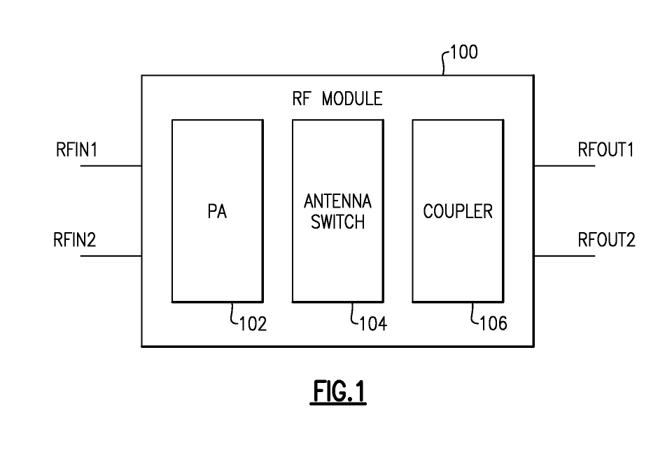

FIG. 1 depicts a radio-frequency (RF) module 100 that includes a number of components to accommodate such an additional antenna. Although described in the context of dual antenna configuration, it will be understood that one or more features of the present disclosure can also be implemented for an RF system having more than two antennas.

In FIG. 1, the RF module 110 is shown to include a PA 102, an antenna switch 104, and a coupler 106. Additional details concerning such components are described herein in greater detail. The RF module 110 is shown to receive first and second inputs (RFin1, RFin2) and generate first and second outputs (RFout1, RFout2) for transmission through their respective antennas (not shown in FIG. 1). In some embodiments, substantially all of the PA 102, the antenna switch 104, and the coupler 106 can be implemented in the RF module 100.

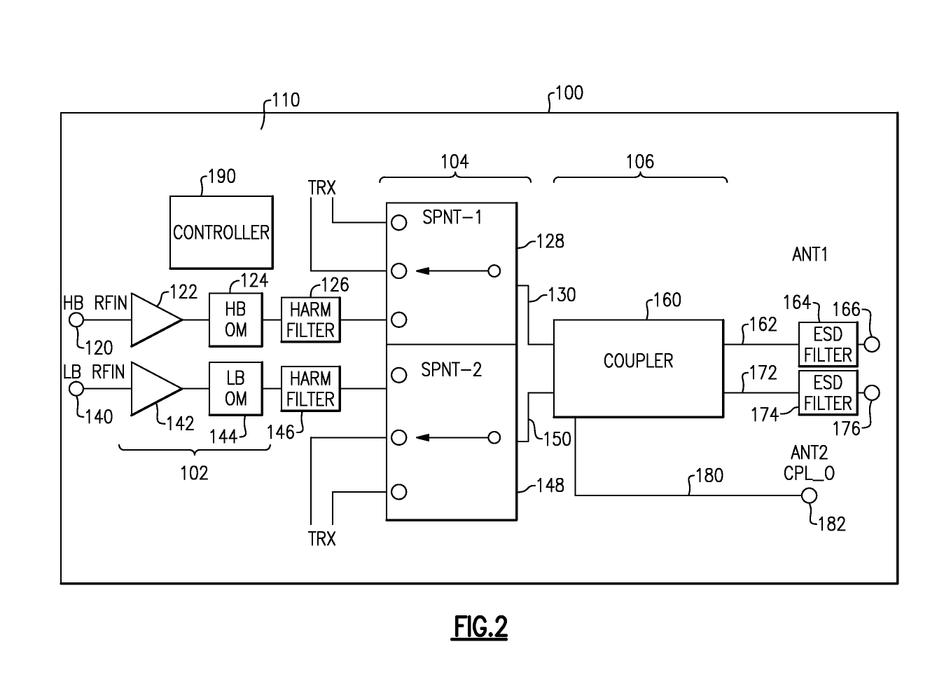

FIG. 2 shows an RF module 100 that can be a more specific example of the RF module 100 of FIG. 1. In FIG. 2, the RF module is depicted in the example context of a TX FEM (transmitting front end module). However, it will be understood that one or more features of the present disclosure can also be implemented in other types of RF modules.

In the example of FIG. 2, the TX FEM 100 is shown to include a packaging substrate 110 configured to receive and support a plurality of components. Such a packaging substrate can include, for example, a laminate substrate, a ceramic substrate, etc. The PA component is generally indicated as 102; the antenna switch component is generally indicated as 104; and the coupler component is generally indicated as 106.

By way of an example, the PA component 102 is shown to include a high band (HB) amplification path and a low band (LB) amplification path. RF signals associated with the HB path can be received through an input node 120 as HB_RFin, and be amplified by one or more stages of an HB power amplifier (PA) 122. RF signals associated with the LB path can be received through an input node 140 as LB_RFin, and be amplified by one or more stages of an LB power amplifier (PA) 142.

The amplified output of the HB PA 122 can be passed through, for example, a matching network 124 and a harmonic filter 126, and be provided to the antenna switch 104. Similarly, the amplified output of the LB PA 142 can be passed through, for example, a matching network 144 and a harmonic filter 146, and be provided to the antenna switch 104.

In some embodiments, the antenna switch 104 can include a high band portion 128 and a low band portion 148. For example, if the antenna switch 104 has a DPNT (double-pole N-throw) configuration with the two poles for accommodating two antennas, the high band portion 128 can have an SPXT (single-pole X-throw) configuration, and the low band portion 148 can have an SPYT (single-pole Y-throw) configuration. In the example shown in FIG. 2, the value of X is 3, and the value of Y is 3. It will be understood that other values of X and Y can also be implemented.

In the example of FIG. 2, the single throw of the high band portion 128 of the antenna switch 104 is shown to be coupled to a first antenna port 166 through path 130, a coupler 160, path 162, and an ESD/filter circuit 164. Similarly, the throw of the low band portion 148 of the antenna switch 104 is shown to be coupled to a second antenna port 176 through path 150, the coupler 160, path 172, and an ESD/filter circuit 174. An output of the coupler 160 is shown to be provided to a node 182 (CPL_O) through path 180.

In the example of FIG. 2, one of the throws in the high band portion 128 of the antenna switch 104 is shown to be connected to the harmonic filter 126 so as to receive the amplified HB signal. The other throws are shown to be utilized for RX functionality of the high band associated with HB_RFin, and/or TX/RX functionalities of other high bands.

Similarly, one of the throws in the low band portion 148 of the antenna switch 104 is shown to be connected to the harmonic filter 146 so as to receive the amplified LB signal. The other throws are shown to be utilized for RX functionality of the low band associated with LB_RFin, and/or TX/RX functionalities of other low bands.

In some embodiments, the coupler 160 can be implemented as an integrated passive device (IPD). In some embodiments, a single IPD can be configured to include two dedicated coupler circuits for the high band and low band channels. In some embodiments, a first IPD can be configured to include a first coupler circuit for the high band, and a separate second IPD can be configured to include a second coupler circuit for the low band.

In some embodiments, the foregoing coupler (160) can be configured to detect the transmitting power of either or both of the high band signal and the low band signal. As shown in FIG. 2, the two outputs of the coupler 160 are shown to be routed to the two dedicated antenna ports 166, 176.

In the example of FIG. 2, the TX FEM 100 is shown to further include a controller component 190 configured to facilitate operation of some or all parts of the module (100). Although not shown, the module 100 can also include circuits, connections, etc. configured to facilitate, for example, supply power, bias signal, etc.

In some embodiments, the PAs 122, 142 can be implemented in a suitable configuration for RF applications such as cellular applications. For example, GaAs based devices such as HBT devices, or silicon based devices can be utilized.

In some embodiments, the antenna switch 104 can be implemented in a suitable configuration for RF applications such as cellular applications. For example, silicon-on-insulator (SOI) technology can be implemented to effectuate various switching FETs.

In some embodiments, various components associated with the PA component 102, the antenna switch 104, and the coupler component 106 can be implemented as semiconductor die. Such die can be packaged as wirebond type, flip-chip type, or in any combination of known package types.

In some embodiments, a module such as a TX FEM as described herein can integrate substantially all components that are needed or desired in a phone design, from transceiver outputs to corresponding antennas. As described herein, such a module can include a power amplifier component, corresponding matching networks, harmonic filters, T/R switch, couplers, and ESD protection network.

In some embodiments, the foregoing module can be implemented in a very compact size. For example, a TX FEM having one or more features as described herein can have lateral dimensions of approximately 5.5 mm×5.3 mm. In addition to the compact size of the TX FEM, incorporation of one or more components into the module can further reduce the area required on a phone board for functionality provided by the TX FEM in a significant manner. Further, BOM cost associated with such TX FEM functionality can also be reduced significantly.

In some implementations, an architecture, a device and/or a circuit having one or more features described herein can be included in an RF device such as a wireless device. Such an architecture, a device and/or a circuit can be implemented directly in the wireless device, in one or more modular forms as described herein, or in some combination thereof. In some embodiments, such a wireless device can include, for example, a cellular phone, a smart-phone, a hand-held wireless device with or without phone functionality, a wireless tablet, a wireless router, a wireless access point, a wireless base station, etc.

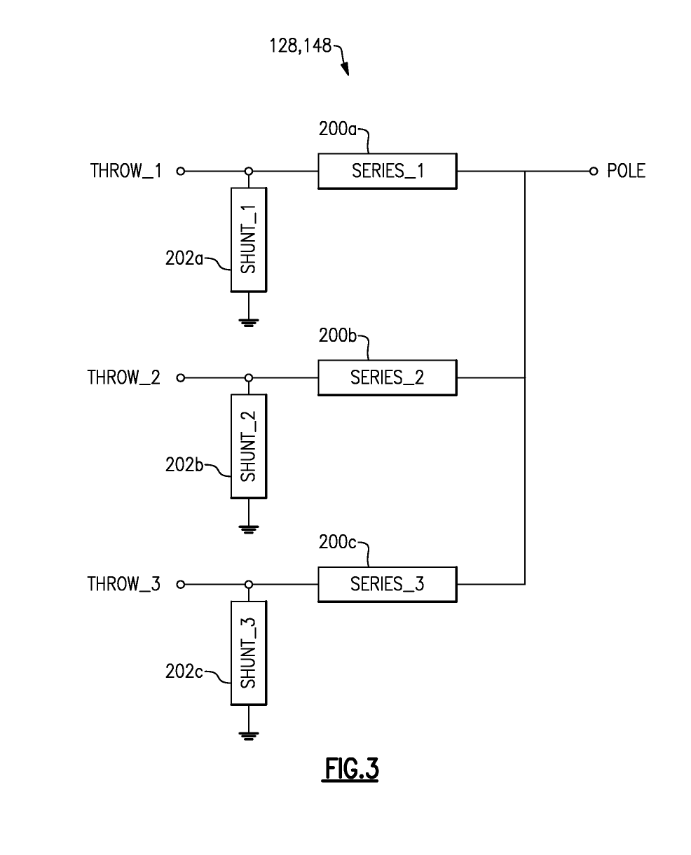

FIG. 3 shows an example switching topology that can be implemented for each of the switches 128 and 148 of FIG. 2. In the example of FIG. 3, a common pole (Pole) is shown to be coupled to each of three throws (Throw_1, Throw_2, Throw_3) through respective switching arms 200a, 200b, 200c (Series_1, Series_2, Series_3). A node associated with each throw can be coupled to ground through a shunt switching arm. Accordingly, a first throw is shown to be coupled to ground through a first shunt arm 202a (Shunt_1), a second throw is shown to be coupled to ground through a second shunt arm 202b (Shunt_2), and a third throw is shown to be coupled to ground through a third shunt arm 202c (Shunt_3).

In some embodiments, the foregoing example switching topology can provide the example SP3T switching functionality by appropriate control of the switching arms. For example, when Throw_1 is to be connected to Pole, the Series_1 switching arm can be turned ON, while the Series_2 and Series_3 switching arms are turned OFF. For such a routing configuration (Throw_1 to Pole), the first shunt arm (Shunt_1) can be turned OFF, while the second and third shunt arms (Shunt_2, Shunt_3) are turned ON. Similar switching configuration can be implemented when routing of signal between Throw_2 and Pole or Throw_3 and Pole is desired. In many RF applications, such switching configurations can provide, for example, improved isolation between different channels associated with the switch (128 or 148).

FIG. 4 shows a more specific example of the switching topology 128, 124 of FIG. 3. In the example of FIG. 4, each of the switching arms 200a, 200b, 200c (Series_1, Series_2, Series_3 in FIG. 3) can be implemented as a plurality of field-effect transistors (FETs) 204 arranged in a stack. Similarly, each of the shunt arms 202a, 202b, 202c (Shunt_1, Shunt_2, Shunt_3 in FIG. 3) can be implemented as a plurality of field-effect transistors (FETs) 206 arranged in a stack.

In some embodiments, the foregoing stacks of FETs 204, 206 can be operated by providing appropriate bias signals to, for example, gates and bodies of the FETs. It will be understood that the numbers of FETs in a stack of a switching arm (200a, 200b, or 200c) may or may not be the same as the numbers of FETs in a stack of a shunt arm (202a, 202b, or 202c).

In some embodiments, the switching arms 200a, 200b, 200c (Series_1, Series_2, Series_3 in FIG. 3) and the shunt arms 202a, 202b, 202c (Shunt_1, Shunt_2, Shunt_3 in FIG. 3) can be implemented as, for example silicon-on-insulator (SOI) devices. In some embodiments, each of the switches 128 and 148 of FIGS. 2-4 can be implemented on a common SOI die. In some embodiments, the switch 128 of FIGS. 2-4 can be implemented on a first SOI die, and the switch 148 of FIGS. 2-4 can be implemented on a second SOI die. It will be understood that such switches 128, 148 can also be implemented in other configurations.

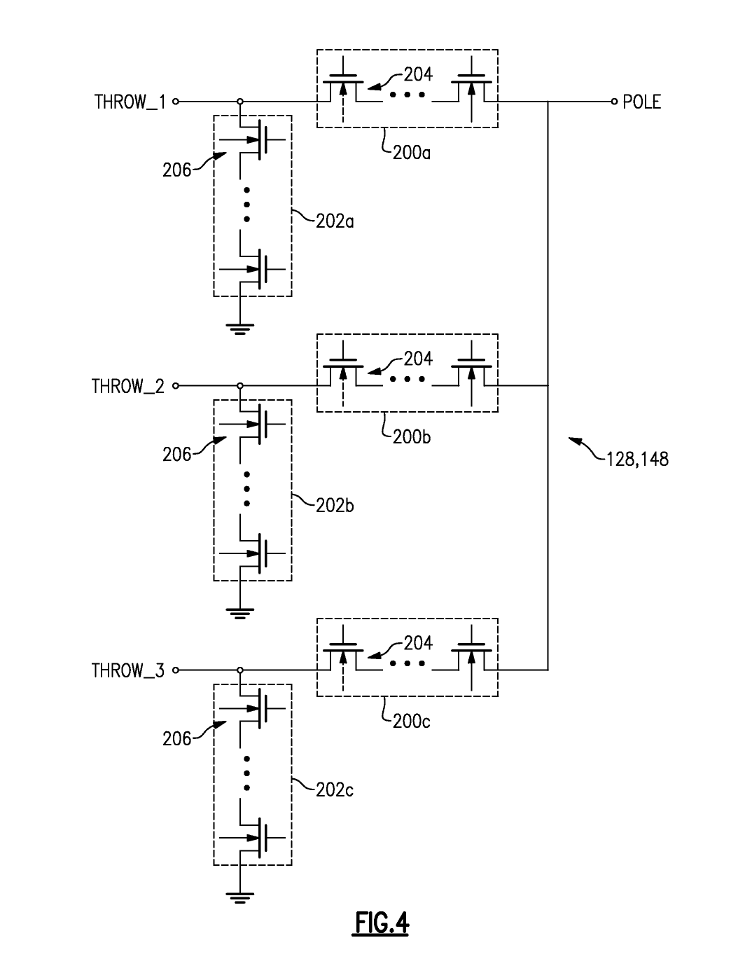

FIG. 5 depicts a more detailed example of the coupler 160 of FIG. 2. FIG. 5 shows that in some embodiments, a coupler 160 can be implemented as an integrated passive device (IPD) having various circuits and components on a substrate 210. Such an IPD coupler can include input pins 212, 222 that are coupled to respective output pins 216, 226 through respective signal paths 214, 224. For example, the input pins 212, 222 can be configured to be connected to signal paths 130, 150 of FIG. 2, respectively. Similarly, the output pins 216, 226 can be configured be connected to signal paths 162, 172 of FIG. 2.

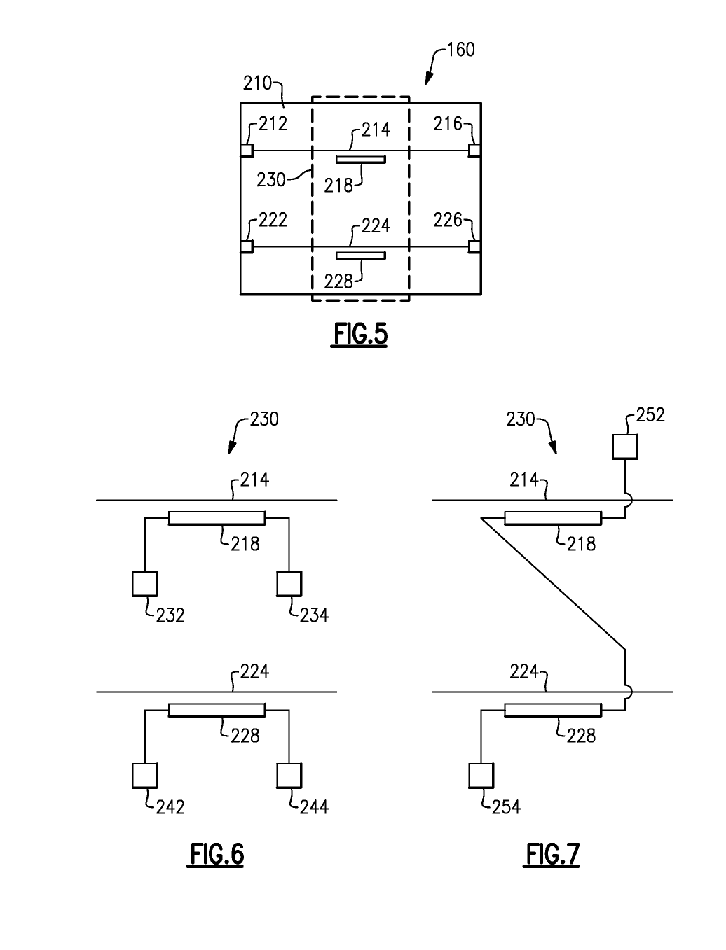

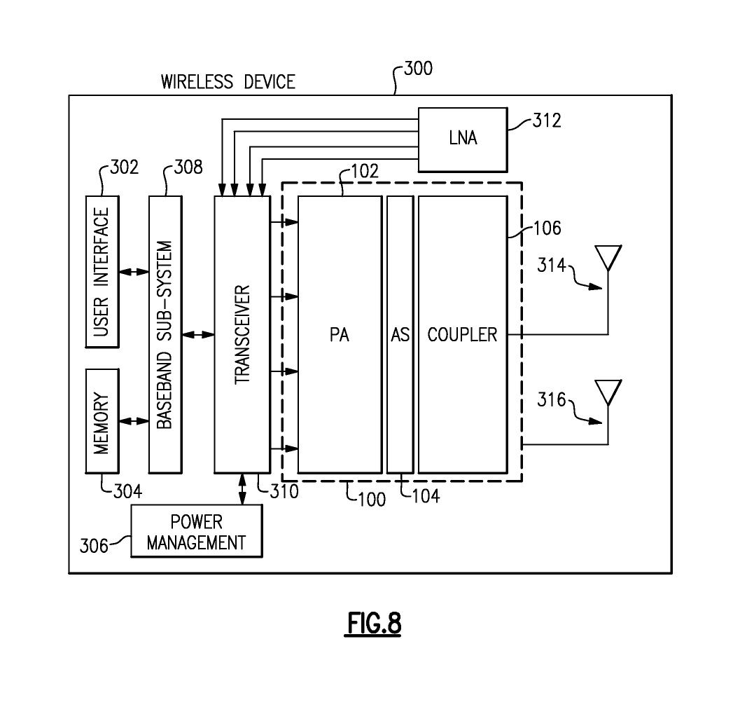

In the example of FIG. 5, the IPD coupler 160 can further include coupling elements 218, 228 implemented relative to respective signal paths 214, 224. Such coupling elements can be parts of a coupling assembly generally depicted as 230. FIGS. 6 and 7 show non-limiting examples of how such a coupling assembly can be configured.

FIG. 6 shows that in some embodiments, the coupling assembly 230 of FIG. 5 can include first and second coupling circuits that are generally independent of each other. For example, the first coupling circuit can include input and output pins 232, 234 that are connected to respective ends of the first coupling element 218. Similarly, the second coupling circuit can include input and output pins 242, 244 that are connected to respective ends of the second coupling element 228.

FIG. 7 shows that in some embodiments, the coupling assembly 230 of FIG. 5 can include a coupling circuit implemented in a chain configuration. For example, such a coupling circuit can include an input pin 252 connected to an output pin 254 through the first and second coupling elements 218, 228 in a daisy-chain configuration.

It will be understood that other configurations can also be implemented for the coupler 160 of FIG. 5.

FIG. 8 schematically depicts an example wireless device 300 having one or more advantageous features described herein. In some embodiments, such advantageous features can be implemented in a module 100 such as a front-end (FE) module.

PAs in a PA component 102 can receive their respective RF signals from a transceiver 310 that can be configured and operated in known manners to generate RF signals to be amplified and transmitted, and to process received signals. The transceiver 310 is shown to interact with a baseband sub-system 308 that is configured to provide conversion between data and/or voice signals suitable for a user and RF signals suitable for the transceiver 310. The transceiver 310 is also shown to be connected to a power management component 306 that is configured to manage power for the operation of the wireless device 300. Such power management can also control operations of the baseband sub-system 308 and other components of the wireless device 300.

The baseband sub-system 308 is shown to be connected to a user interface 302 to facilitate various input and output of voice and/or data provided to and received from the user. The baseband sub-system 308 can also be connected to a memory 304 that is configured to store data and/or instructions to facilitate the operation of the wireless device, and/or to provide storage of information for the user.

In the example wireless device 300, the front end module 100 can include the PA component 102, an antenna switch 104, and a coupler component 106 as described herein. In FIG. 8, some received signals are shown to be routed from the front end module 100 to one or more low-noise amplifiers (LNAs) 312. Amplified signals from the LNAs 312 are shown to be routed to the transceiver 310.

A number of other wireless device configurations can utilize one or more features described herein. For example, a wireless device does not need to be a multi-band device. In another example, a wireless device can include additional antennas such as diversity antenna, and additional connectivity features such as Wi-Fi, Bluetooth, and GPS.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

The teachings of the invention provided herein can be applied to other systems, not necessarily the system described above. The elements and acts of the various embodiments described above can be combined to provide further embodiments.

While some embodiments of the inventions have been described, these embodiments have been presented by way of example only, and are not intended to limit the scope of the disclosure. Indeed, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

What is claimed is:

1. A front-end module (FEM) comprising:
a packaging substrate configured to receive a plurality of components;
a first input port and a second input port configured to receive respective radio-frequency (RF) signals for amplification;
a first antenna port and a second antenna port configured to output the amplified RF signals to respective antennas; and
a front-end circuit implemented between the input ports and the antenna ports, the front-end circuit including a power amplifier (PA) for each of the first and second input ports, the front-end circuit further including an antenna switch configured to route the amplified RF signals from the PAs to their respective antenna ports, the front-end circuit further including a coupler implemented between the antenna switch and the antenna ports, the coupler configured to detect output power of the amplified RF signals.

2. The FEM of claim 1 wherein the front-end circuit includes substantially all components needed to couple first and second frequency band outputs of a transceiver to the respective antennas for transmit operations involving the first and second frequency bands.

3. The FEM of claim 2 wherein the first frequency band is a high band and the second frequency band is a low band.

4. The FEM of claim 3 wherein the front-end circuit further includes an output matching network implemented at the output of each of the first and second PAs.

5. The FEM of claim 4 wherein the front-end circuit further includes a harmonic filter implemented at the output of each of the first and second output matching networks.

6. The FEM of claim 3 wherein the antenna switch includes a DPNT (double-pole N-throw) configuration, the double poles coupled to the first and second antenna ports through the coupler.

7. The FEM of claim 6 wherein the N throws and the double throws of the antenna switch are divided into a high band portion having an SPXT (single-pole X-throw) configuration and a low band portion having an SPYT (single-pole Y-throw) configuration.

8. The FEM of claim 7 wherein one of the X-throws of the high band portion is connected to an output of the high band PA, and one of the Y-throws of the low band portion is connected to an output of the low band PA.

9. The FEM of claim 3 wherein the coupler is implemented as an integrated passive device (IPD).

10. The FEM of claim 9 wherein the IPD includes a dedicated coupler circuit for each of the high band and the low band.

11. The FEM of claim 10 wherein the front-end circuit further includes an electrostatic discharge (ESD) protection circuit implemented between each dedicated coupler circuit and the corresponding antenna port.

12. The FEM of claim 10 wherein the front-end circuit further includes a filter implemented between each dedicated coupler circuit and the corresponding antenna port.

13. A radio-frequency (RF) device comprising:
a transceiver configured to process RF signals;
a front-end module (FEM) in communication with the transceiver, the FEM including a packaging substrate configured to receive a plurality of components, the FEM further including a first input port and a second input port configured to receive respective RF signals for amplification, the FEM further including a first antenna port and a second antenna port configured to output the respective amplified RF signals, the FEM further including a front-end circuit implemented between the input ports and the antenna ports, the front-end circuit including a power amplifier (PA) for each of the first and second input ports, the front-end circuit further including an antenna switch configured to route the amplified RF signals from the PAs to their respective antenna ports, the front-end circuit further including a coupler implemented between the antenna switch and the antenna ports, the coupler configured to detect output power of the amplified RF signals; and
a first antenna and a second antenna connected to the first and second antenna ports, respectively, the first and second antennas configured to facilitate transmission of their respective amplified RF signals.

14. The RF device of claim 13 wherein the RF device includes a wireless device.

15. The RF device of claim 14 wherein the wireless device is a cellular phone.

16. The RF device of claim 13 wherein the transceiver is in communication with a baseband sub-system, the baseband sub-system configured to provide conversion between data and/or voice signals.

17. The RF device of claim 16 wherein the baseband sub-system is in communication with a user interface.

18. The RF device of claim 13 wherein the FEM is in communication with one or more low-noise amplifiers (LNAs) and amplified signals from the one or more LNAs are routed to the transceiver.

19. The RF device of claim 13 wherein the coupler of the FEM is implemented as an integrated passive device (IPD).

20. A method for fabricating a front-end module (FEM), the method comprising:
providing a packaging substrate configured to receive a plurality of components;
setting a first input port and a second input port configured to receive respective radio-frequency (RF) signals for amplification;
setting a first antenna port and a second antenna port configured to output the amplified RF signals to respective antennas; and
incorporating a front-end circuit implemented between the input ports and the antenna ports, the front-end circuit including a power amplifier (PA) for each of the first and second input ports, the front-end circuit further including an antenna switch configured to route the amplified RF signals from the PAs to their respective antenna ports, the front-end circuit further including a coupler implemented between the antenna switch and the antenna ports, the coupler configured to detect output power of the amplified RF signals.
